(19) United States
(12) Patent Application Publication
(10) Pub. No.: US 2016/0196084 A1
(43) Pub. Date: Jul. 7, 2016

(54) HARD DISK DEVICE WITH REDUCED POWER CONSUMPTION AND POWER CONSUMPTION REDUCING METHOD THEREOF

(71) Applicant: Primax Electronics Ltd., Taipei (TW)

(72) Inventor: CHEN-NING HSI, Taipei (TW)

(21) Appl. No.: 14/723,034

(22) Filed: May 27, 2015

(30) Foreign Application Priority Data
Jan. 4, 2015 (CN) 201510001915.9

(51) Int. Cl. G06F 3/06

(52) U.S. Cl. CPC G06F 3/0625; G06F 3/0659; G06F 3/0674

(57) ABSTRACT

A power consumption reducing method for a hard disk device is provided. The power consumption reducing method includes a connecting step, plural requesting steps, a recording step, plural detecting steps, a transmitting step, a partitioning step and a subsequent transmitting step. During the operation of a high power consumption storage component, an object file or at least one file segment of the object file is copied from the high power consumption storage component to a low power consumption storage component. When an active device requests the object file from the hard disk device, the object file is transmitted from the low power consumption storage component to the active device. Consequently, the total run time of the high power consumption storage component is reduced.

### FIELD OF THE INVENTION

The present invention relates to a hard disk device, and more particularly to a hard disk device that is not continuously connected to a power source.

### BACKGROUND OF THE INVENTION

With the progress of the times, computers are popular to ordinary families. Moreover, each family may possess plural computers. Generally, a computer comprises a display screen and a host. The host comprises a motor type hard disk, a memory, a main board, a network interface, an audio interface, an operation system and other components. The motor type hard disk is used for storing data. Consequently, the motor type hard disk is a very important component of the computer.

The operations of the motor type hard disk will be illustrated as follows. Generally, the motor type hard disk comprises a disk, a first motor, a second motor and a pickup head. The first motor is connected with the disk for controlling the rotation of the disk. The second motor is connected with the pickup head for controlling the movement of the pickup head. When the first motor is enabled, the disk is driven to rotate. Moreover, when the second motor is enabled, the pickup head is moved to a corresponding sector of the disk so as to read the data of the disk.

Generally, the files to be used are usually searched from the motor type hard disk by the user. For example, the user may search a document file from the My Documents directory in the disk “C” of the computer. When the user enters the disk “C”, the first motor and the second motor are enabled. Consequently, the sector corresponding to the disk “C” in the motor type hard disk is read by the pickup head. Then, when the user enters the folder of the My Documents directory, the first motor and the second motor are enabled again. Consequently, the sector corresponding to the My Documents directory is read by the pickup head. After the above operations of the hard disk are performed, all files contained in the folder of the My Documents directory are shown on the display screen of the computer. Subsequently, the user may select a desired document file with the naked eyes.

As mentioned above, during the operation of the motor type hard disk, the first motor and the second motor are frequently rotated. In other words, a great deal of electric power is consumed. In case that the motor type hard disk is installed in a desktop computer, power consumption is not an important issue because the power cable of the desktop computer is continuously connected to a power source. However, if the motor type hard disk is not continuously connected to the power source, it is necessary to reduce the power consumption in order to extend the run time of the motor type hard disk. For example, the motor type hard disk that is not continuously connected to the power source is a motor type hard disk for a notebook computer or a wireless motor type hard disk.

Therefore, there is a need of providing a hard disk device with reduced power consumption and a power consumption reducing method for the hard disk device.

### SUMMARY OF THE INVENTION

An object of the present invention provides a hard disk device with reduced power consumption and a power consumption reducing method for the hard disk device.

In accordance with an aspect of the present invention, there is provided a power consumption reducing method for a hard disk device. The power consumption reducing method includes the following steps. Firstly, the hard disk device is connected with an active device. Then, the hard disk device judges whether the hard disk device is connected with the active device for a first time. A first requesting step is selectively performed for allowing an object file or at least one file segment of the object file to be copied from a high power consumption storage component of the hard disk device to a low power consumption storage component of the hard disk device according to a request command from the active device, and an operating behavior of the active device is recorded as an operating practice information. A second requesting step is selectively performed for allowing the object file or the at least one file segment of the object file to be copied from the high power consumption storage component to the low power consumption storage component according to the operating practice information. Then, the object file or the at least one file segment of the object file is transmitted to the active device. Then, the hard disk device judges whether all file segments of the object file are completely transmitted to the active device.

In accordance with another aspect of the present invention, there is provided a hard disk device with reduced power consumption. The hard disk device being is connected with an active device. The hard disk device includes a high power consumption storage component, a low power consumption storage component, a controlling unit and a prediction module. The high power consumption storage component is disposed within the hard disk device, and stores an object file. The low power consumption storage component is disposed within the hard disk device and connected with the high power consumption storage component. The controlling unit is connected with the high power consumption storage component and the low power consumption storage component. According to a request command from the active device, the object file or at least one file segment of the object file is copied from the high power consumption storage component to the low power consumption storage component by the controlling unit, and the object file or the at least one file segment is transmitted from the low power consumption storage component to the active device by the controlling unit. The prediction module is connected with the controlling unit. According to the request command, an operating behavior of the active device is recorded as an operating practice information by the prediction module. When the active device is connected with the hard disk device not for a first time, the object file or the at least one file segment corresponding to the operating practice information is copied from the high power consumption storage component to the low power consumption storage component by the controlling unit according to the operating practice information of the prediction module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the relationship between a hard disk device with reduced power consumption and an active device;

FIG. 2 is a flowchart illustrating a power consumption reducing method for the hard disk device according to a first embodiment of the present invention;

FIG. 3 is a flowchart illustrating the first requesting step B of the power consumption reducing method according to the first embodiment of the present invention;

FIG. 4 is a flowchart illustrating the recoding step D of the power consumption reducing method according to the first embodiment of the present invention;

FIG. 5 is a flowchart illustrating the second requesting step C of the power consumption reducing method according to the first embodiment of the present invention;

FIG. 6 is a flowchart illustrating the third requesting step G of the power consumption reducing method according to the first embodiment of the present invention;

FIG. 7 is a schematic functional block diagram illustrating the way of partitioning the first object file into plural file segments by the power consumption reducing method of the present invention;

FIG. 8 is a flowchart illustrating a power consumption reducing method for the hard disk device according to a second embodiment of the present invention;

FIG. 9 is a flowchart illustrating the recoding step D* of the power consumption reducing method according to the second embodiment of the present invention; and

FIG. 10A and FIG. 10B are flowcharts illustrating the second requesting step C* of the power consumption reducing method according to the second embodiment of the present invention.

### DETAILED DESCRIPTION OF THE PREFERRED EMBODIMENT

For obviating the drawbacks of the prior art technologies, the present invention provides a hard disk device.

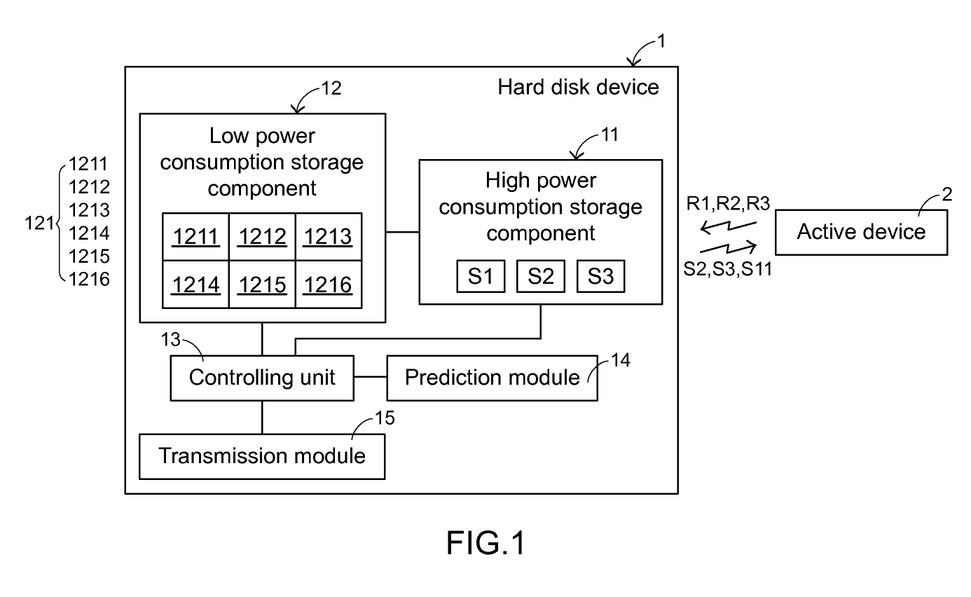

Hereinafter, the structure of a hard disk device with reduced power consumption will be illustrated with reference to FIG. 1. FIG. 1 is a schematic functional block diagram illustrating the relationship between a hard disk device with reduced power consumption and an active device. In this embodiment, the hard disk device 1 is connected with an active device 2 by a wireless transmission technology. The hard disk device 1 may store a first object file S1, a second object file S2 and a third object file S3. Moreover, the hard disk device 1 comprises a high power consumption storage component 11, a low power consumption storage component 12, a controlling unit 13, a prediction module 14 and a transmission module 15. The high power consumption storage component 11 is disposed within the hard disk device 1 for storing the first object file S1, the second object file S2 and the third object file S3. In this embodiment, the first object file S1 is a video file, the second object file S2 is a document file, and the third object file S3 is an audio file.

The low power consumption storage component 12 is disposed within the hard disk device 1 and connected with the high power consumption storage component 11. According to the practical requirements, the first object file S1, the second object file S2 or the third object file S3 may be temporarily stored in the low power consumption storage component 12. The consumed electric quantity of the high power consumption storage component 11 during operation is larger than the consumed electric quantity of the low power consumption storage component 12 during operation. In this embodiment, the hard disk device 1 is a wireless hard disk device, the high power consumption storage component 11 is a motor type hard disk, and the low power consumption storage component 12 is a flash memory. Moreover, the active device 2 is a smart phone.

As shown in FIG. 1, the controlling unit 13 is connected with the high power consumption storage component 11 and the low power consumption storage component 12. The controlling unit 13 has four functions. In accordance with the first function, the controlling unit 13 may copy a corresponding object file or at least one file segment of the corresponding object file from the high power consumption storage component 11 to the low power consumption storage component 12 according to a first request command R1 from the active device 2. In accordance with the second function, the controlling unit 13 may manage the storage space of the low power consumption storage component 12. In accordance with the third function, the controlling unit 13 may judge the file attributes of the first object file S1, the second object file S2 or the third object file S3, and calculate the power consumption rates of the first object file S1, the second object file S2 or the third object file S3 in the low power consumption storage component 12. In accordance with the fourth function, the controlling unit 13 may recognize the identity of the active device 2. The prediction module 14 is connected with the controlling unit 13. The operating behavior of the active device 2 according to the first request command R1 from the active device 2 is recorded as an operating practice information by the prediction module 14. In this context, the operation of the active device 2 denotes the object file to be request by the active device 2, the folder browsed by the active device 2 and associated information. The operations of the controlling unit 13 and prediction module 14 will be illustrated in more details later.

The transmission module 15 is disposed within the hard disk device 1 and connected to the controlling unit 13. The transmission module 15 is connected with the low power consumption storage component 12 through the controlling unit 13. Moreover, the transmission module 15 may be connected with the active device 2 or a second active device (not shown) by a wireless transmission technology. In this embodiment, the transmission module 15 is connected with the active device 2 or the second active device by a Wi-Fi transmission technology. Preferably but not exclusively, the controlling unit 13 and the prediction module 14 are independent microprocessors or controlling circuits. Alternatively, in another embodiment, the controlling unit and the prediction module may be integrated into the same microprocessor or the same controlling circuit.

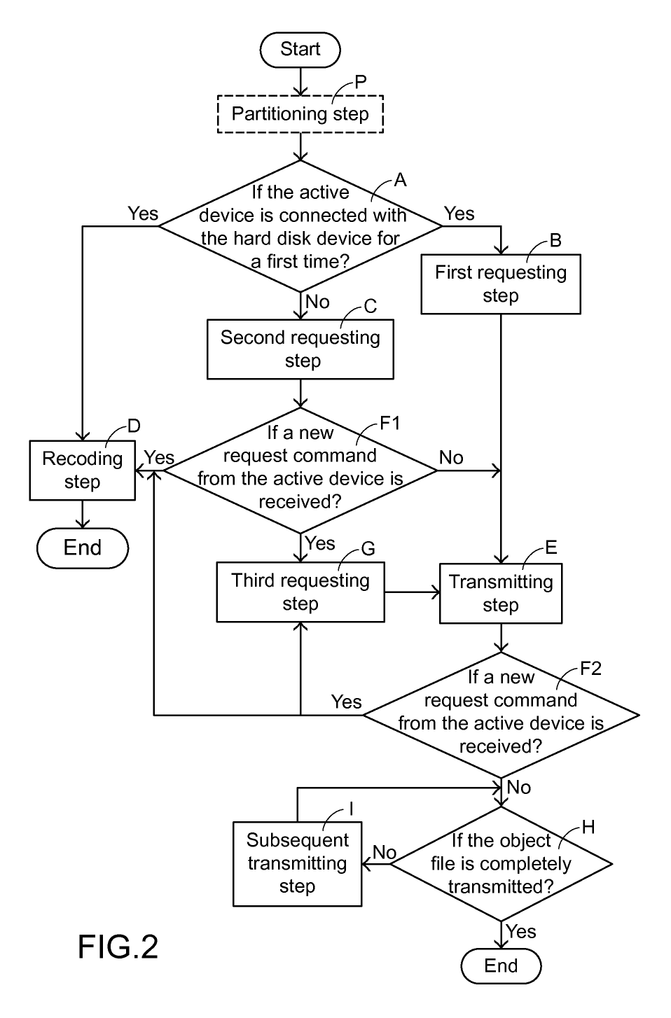

Hereinafter, a power consumption reducing method for the hard disk device will be illustrated with reference to FIG. 2. FIG. 2 is a flowchart illustrating a power consumption reducing method for the hard disk device according to a first embodiment of the present invention. The power consumption reducing method for the hard disk device comprises the following steps. In a partitioning step P, the storage space of the low power consumption storage component is allocated into plural consecutive sub-storage spaces, and the plural consecutive sub-storage spaces are assigned to the active device. In a connecting step A, the hard disk device is connected with the active device and judges whether the active device is connected with the hard disk device for a first time. In a first requesting step B, a corresponding object file or at least one file segment of the corresponding object file is copied from the high power consumption storage component to the low power consumption storage component according to a first request command from the active device. In a second requesting step C, a corresponding object file or at least one file segment of the corresponding object file is copied from the high power consumption storage component to the low power consumption storage component according to an operating practice information. In a recoding step D, the operating behavior of the active device is recorded as an operating practice information. In a transmitting step E, the corresponding object file or the at least one file segment is transmitted to the active device. The detecting steps F1 and F2 are performed to judge whether a new request command from the active device is received. In a third requesting step G, a corresponding object file or at least one file segment of the corresponding object file is copied from the high power consumption storage component to the low power consumption storage component according to the new request command from the active device. The transmission judging step H is performed to judge whether the object file is completely transmitted. In a subsequent transmitting step I, a next file segment is copied from the high power consumption storage component to the low power consumption storage component, and the next file segment is transmitted to the active device.

In the connecting step A, if the controlling unit 13 judges that the active device is connected with the hard disk device for the first time, the first requesting step B and the recoding step D are performed. Whereas, if the controlling unit 13 judges that the active device is connected with the hard disk device not for the first time, the second requesting step C is performed. In the detecting step F1, if the controlling unit 13 judges that the new request command from the active device is received, the third requesting step G and the recoding step D are performed. Whereas, if the controlling unit 13 judges that no new request command from the active device is received after a predetermined time period, the transmitting step E is performed. In the detecting step F2, if the controlling unit 13 judges that the new request command from the active device is received, the third requesting step G and the recoding step D are performed. Whereas, if the controlling unit 13 judges that no new request command from the active device is received after a predetermined time period, the transmission judging step H is performed. In the transmission judging step H, if the controlling unit 13 judges that the object file is not completely transmitted, the subsequent transmitting step I is performed. Whereas, if the controlling unit 13 judges that the object file is completely transmitted, the flowchart of the present invention is ended.

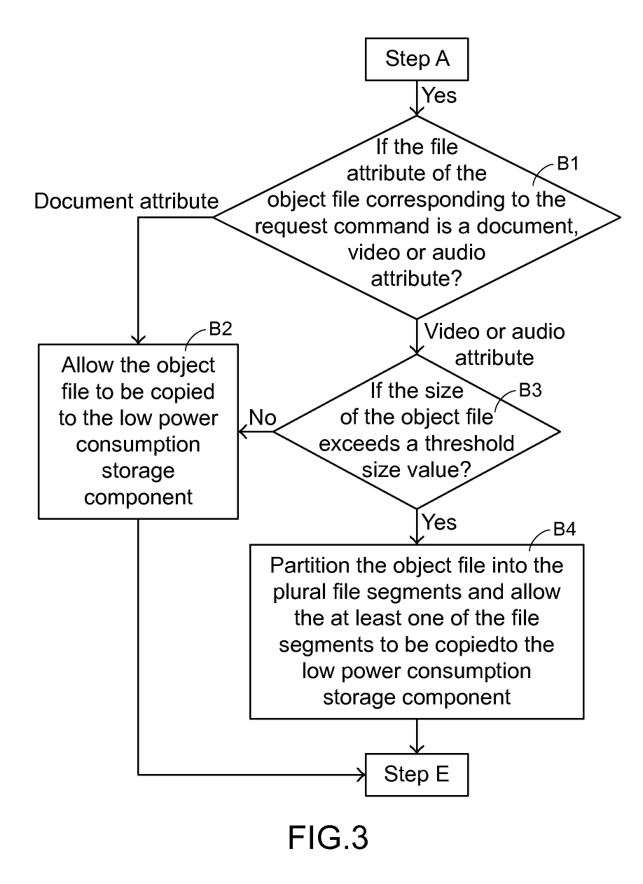

The detailed procedures of the first requesting step B of the power consumption reducing method of the present invention will be illustrated as follows. FIG. 3 is a flowchart illustrating the first requesting step B of the power consumption reducing method according to the first embodiment of the present invention. The first requesting step B comprises the following steps B1˜B4. In the step B1, the request command is received, and the file attribute of the object file corresponding to the request command is judged. In the step B2, the object file is copied to the low power consumption storage component. The step B3 is performed to judge whether the size of the object file exceeds a threshold size value. In the step B4, the object file is partitioned into plural file segments and at least one of the file segments is copied to the low power consumption storage component.

In the step B1, if the controlling unit 13 judges that the file attribute of the object file is a document attribute, the step B2 is performed. Whereas, if the controlling unit 13 judges that the file attribute of the object file is a video attribute or an audio attribute, the step B3 is performed. In the step B3, if the controlling unit 13 judges that the size of the object file exceeds the threshold size value, the step B4 is performed. Whereas, if the controlling unit 13 judges that the size of the object file does not exceed the threshold size value, the step B2 is performed.

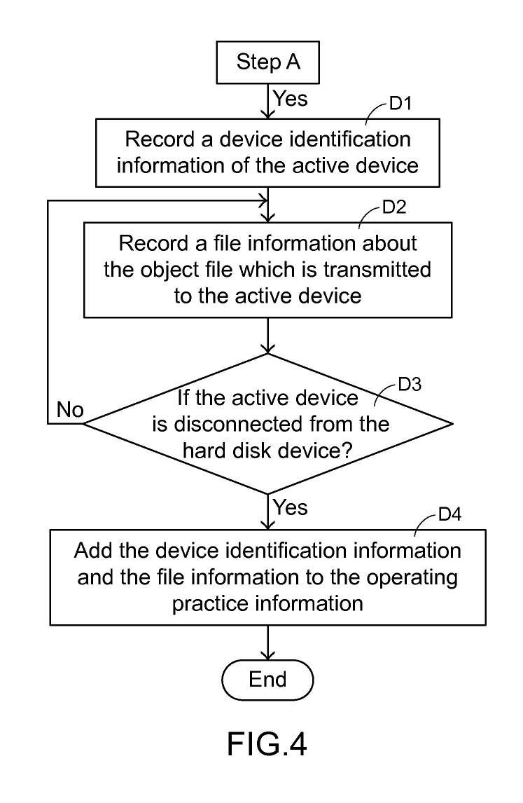

The detailed procedures of the recoding step D of the power consumption reducing method of the present invention will be illustrated as follows. FIG. 4 is a flowchart illustrating the recoding step D of the power consumption reducing method according to the first embodiment of the present invention. The recoding step D comprises the following steps D1˜D4. In the step D1, a device identification information of the active device is recorded. In the step D2, a file information about the object file which is transmitted to the active device is recorded. The step D3 is performed to judge whether the active device is disconnected from the hard disk device. In the step D4, the device identification information and the file information are added to the operating practice information.

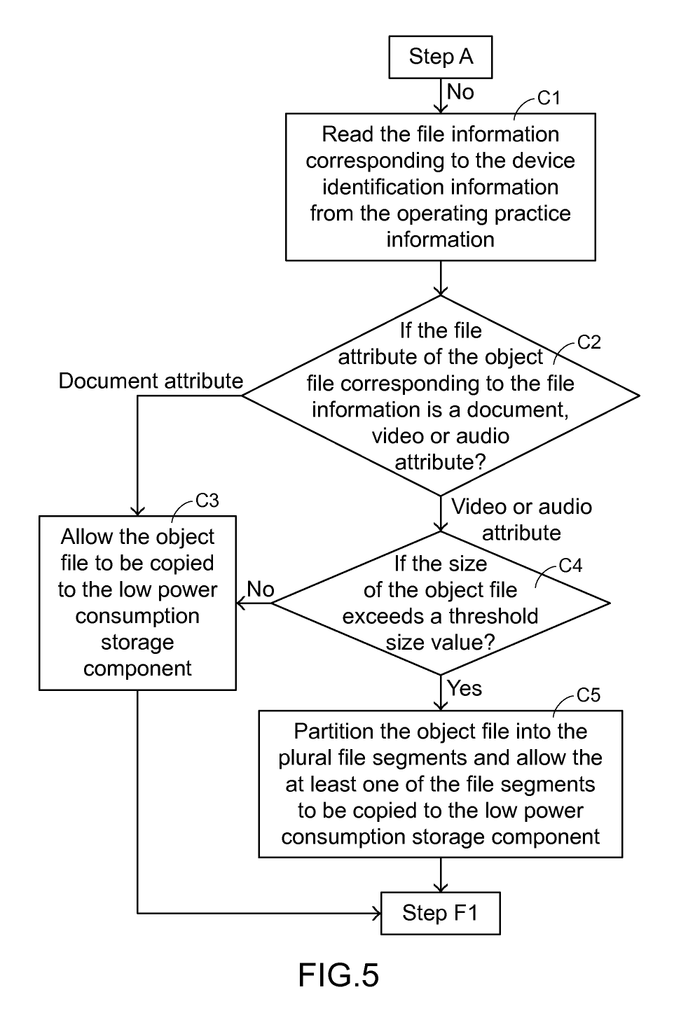

The detailed procedures of the second requesting step C of the power consumption reducing method of the present invention will be illustrated as follows. FIG. 5 is a flowchart illustrating the second requesting step C of the power consumption reducing method according to the first embodiment of the present invention. The second requesting step C comprises the following steps C1˜C5. In the step C1, the file information corresponding to the device identification information is read from the operating practice information. In the step C2, the file attribute of the object file corresponding to the file information is judged. In the step C3, the object file is copied to the low power consumption storage component. The step C4 is performed to judge whether the size of the object file exceeds a threshold size value. In the step C5, the object file is partitioned into plural file segments and at least one of the file segments is copied to the low power consumption storage component.

In the step C2, if the controlling unit 13 judges that the file attribute of the object file is a document attribute, the step C3 is performed. Whereas, if the controlling unit 13 judges that the file attribute of the object file is a video attribute or an audio attribute, the step C4 is performed. In the step C4, if the controlling unit 13 judges that the size of the object file exceeds the threshold size value, the step C5 is performed. Whereas, if the controlling unit 13 judges that the size of the object file does not exceed the threshold size value, the step C3 is performed.

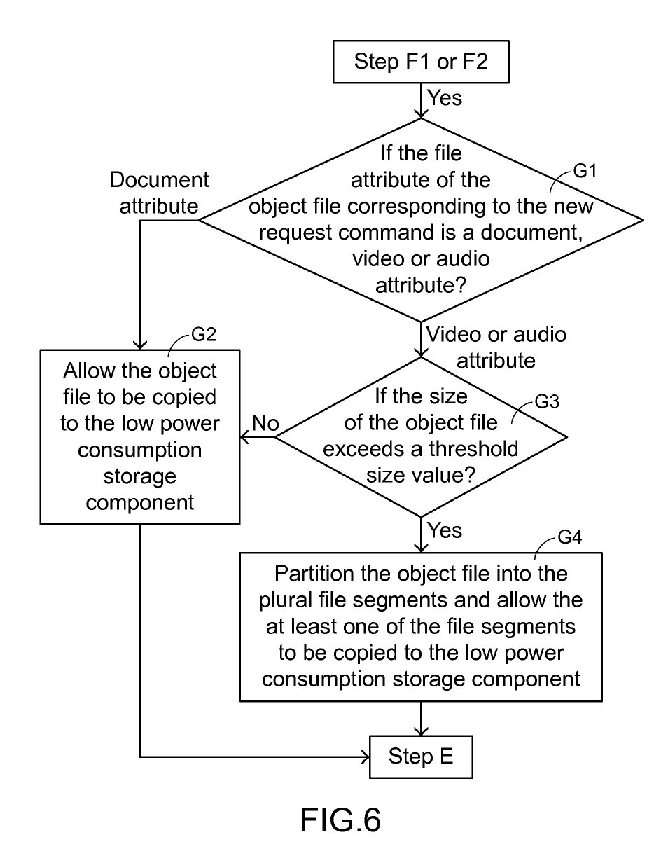

The detailed procedures of the third requesting step G of the power consumption reducing method of the present invention will be illustrated as follows. FIG. 6 is a flowchart illustrating the third requesting step G of the power consumption reducing method according to the first embodiment of the present invention. The third requesting step G comprises the following steps G1˜G4. In the step G1, the file attribute of the object file corresponding to the new request command is judged. In the step G2, the object file is copied to the low power consumption storage component. The step G3 is performed to judge whether the size of the object file exceeds a threshold size value. In the step G4, the object file is partitioned into plural file segments and at least one of the file segments is copied to the low power consumption storage component.

In the step G1, if the controlling unit 13 judges that the file attribute of the object file is a document attribute, the step G2 is performed. Whereas, if the controlling unit 13 judges that the file attribute of the object file is a video attribute or an audio attribute, the step G3 is performed. In the step G3, if the controlling unit 13 judges that the size of the object file exceeds the threshold size value, the step G4 is performed. Whereas, if the controlling unit 13 judges that the size of the object file does not exceed the threshold size value, the step G2 is performed.

Hereinafter, the operations of the power consumption reducing method for the hard disk device will be illustrated with reference to FIGS. 1 and 2. After the power consumption reducing method of the present invention is started, the controlling unit 13 performs the partitioning step P. That is, the storage space 121 of the low power consumption storage component 12 is allocated into plural consecutive sub-storage spaces 1211˜1216. Moreover, the plural consecutive sub-storage spaces 1211, 1212 and 1213 are assigned to the first active device that is connected with the hard disk device 1, and the plural consecutive sub-storage spaces 1214, 1215 and 1216 are assigned to the second active device that is connected with the hard disk device 1. After the partitioning step P, the user may operate the active device 2 to allow the active device 2 to be connected with the hard disk device 1 by a wireless transmission technology. That is, the connecting step A is performed. During the process of establishing the wireless connection between the active device 2 and the hard disk device 1, the active device 2 issues the device identification information to the hard disk device 1. The device identification information contains an identity information, an address information and associated information of the active device 2. After the device identification information is acquired, the controlling unit 13 can recognize the active device 2 according to the device identification information. If the active device 2 is never connected with the hard disk device 1 before, the device identification information corresponding to the active device 2 does not exist in the hard disk device 1. Under this circumstance, since the device identification information is not searched in the connecting step A, the controlling unit 13 judges that the active device 2 is connected with the hard disk device 1 for the first time.

After the wireless connection between the hard disk device 1 and the active device 2 is established, the user may operate the active device 2 to browse the first object file S1, the second object file S2 or the third object file S3 that is stored in the high power consumption storage component 11. If the user wants to open the content of the second object file S2, the user may operate the active device 2 to allow the first request command R1 corresponding to the second object file S2 to be transmitted to the hard disk device 1. Consequently, the hard disk device 1 performs the first requesting step B.

Please refer to FIGS. 1, 2 and 3. Then, the controlling unit 13 performs the step B1. In the step B1, the first request command R1 is received by the controlling unit 13, and the file attribute of the second object file S2 corresponding to the first request command R1 is judged by the controlling unit 13. Since the second object file S2 is a document file, the controlling unit 13 judges that the file attribute of the second object file S2 is a document attribute. Consequently, the step B2 will be performed. Then, the second object file S2 is copied from the high power consumption storage component 11 by the controlling unit 13, so that the copied second object file S2 is stored in the sub-storage space 1211 of the low power consumption storage component 12. Meanwhile, the step B2 is performed. After the first requesting step B is completed, the controlling unit 13 performs the transmitting step E. That is, the second object file S2 in the sub-storage space 1211 is transmitted to the active device 2. Consequently, the second object file S2 is executed by the active device 2.

At the time when the connecting step A is completed, the prediction module 14 performs the recording step D. Please refer to FIGS. 1, 2 and 4. After the active device 2 is recognized by the controlling unit 13, the prediction module 14 performs the step D1 of recording the device identification information of the active device 2. After the second object file S2 is executed by the active device 2, the prediction module 14 performs the step D2. In the step D2, a first file information about the second object file S2 which is transmitted to the active device 2 is recorded. The first file information contains a file name, a file size, a file address and associated information of the second object file S2.

Then, the prediction module 14 performs the step D3 of judge whether the active device 2 is disconnected from the hard disk device 1. If the active device 2 is disconnected from the hard disk device 1, the prediction module 14 performs the step D4 of adding the device identification information and the first file information into the operating practice information. Moreover, the operating practice information is stored in the high power consumption storage component 11 or the low power consumption storage component 12. On the other hand, if the active device 2 is continuously connected with the hard disk device 1 and an additional object file is transmitted to the active device 2 by the controlling unit 13, the prediction module 14 performs the step D2 again. Consequently, the file information about the additional object file is recorded until the active device 2 is disconnected from the hard disk device 1.

After the transmitting step E is completed, the controlling unit 13 performs the detecting step F2 of judging whether a new request command from the active device 2 is received. If the user does not operate the active device 2 to browse other object file of the hard disk device 1, the controlling unit 13 judges that no new request command from the active device 2 is received in the detecting step F2. Consequently, the controlling unit 13 performs the transmission judging step H. Since the second object file S2 corresponding to the first request command R1 has been transmitted to the active device 2, the controlling unit 13 judges that the second object file S2 is completely transmitted in the transmission judging step H. Meanwhile, the procedure of transmitting the second object file S2 is ended.

It is noted that the recording step D is continuously performed by the prediction module 14 while the first requesting step B, the transmitting step E, the detecting step F2 and the transmission judging step H are performed. That is, by the recording step, the integrity of the operating practice information is enhanced.

The procedure of establishing the wireless connection between the active device 2 and the hard disk device 1 for the second time will be illustrated as follows. Please refer to FIGS. 1 and 2 again. After the power consumption reducing method of the present invention is started again, the partitioning step P is no longer performed by the controlling unit 13 because the storage space 121 has been allocated into the plural consecutive sub-storage spaces 1211˜1216. Since the partitioning step P is not performed at each time, the partitioning step P as shown in FIG. 2 is circumscribed by dotted lines. After the user operates the active device 2 to perform the above connecting step A, the wireless connection between the hard disk device 1 and the active device 2 is established again. Since the device identification information corresponding to the active device 2 has existed in the hard disk device 1, in the connecting step A, the controlling unit 13 judges that the active device 2 is connected with the hard disk device 1 not for the first time. Then, the second requesting step C is performed.

Please refer to FIGS. 1, 2 and 5. The controlling unit 13 performs the second requesting step C. In the step C1, the first file information corresponding to the device identification information of the active device 2 is read from the operating practice information by the controlling unit 13. The first file information contains associated information of the second object file S2. The associated information of the second object file S2 was obtained by the prediction module 14 when the active device 2 was connected with the hard disk device 1 for the first time. Then, in the step C2, the file attribute of the second object file S2 is judged by the controlling unit 13.

Since the second object file S2 is the document file, the controlling unit 13 judges that the file attribute of the second object file S2 is the document attribute. Consequently, the step C3 will be performed. Then, the second object file S2 is copied from the high power consumption storage component 11 by the controlling unit 13, so that the copied second object file S2 is stored in the sub-storage space 1211 of the low power consumption storage component 12 again. Meanwhile, the step C3 is performed. After the second requesting step C is completed, the controlling unit 13 performs the detecting step F1 of judging whether a new request command from the active device 2 is received.

If the user wants to open the third object file S3, the user may operate the active device 2 to allow a second request command R2 corresponding to the third object file S3 to be transmitted to the hard disk device 1. Consequently, in the detecting step F1, the controlling unit 13 judges that the second request command R2 is received. Then, the controlling unit 13 performs the third requesting step G Please refer to FIGS. 1, 2 and 6. In the step G1, the file attribute of the third object file S3 corresponding to the second request command R2 is judged by the controlling unit 13. Since the third object file S3 is an audio file, the controlling unit 13 judges that the file attribute of the third object file S3 is an audio attribute. Then, the controlling unit 13 performs the step G3 of judging whether the size of the third object file S3 exceeds a threshold size value. The threshold size value is determined according to the size of the sub-storage space 1211 of the low power consumption storage component 12. In an embodiment, the threshold size value in the controlling unit 13 is 50 MB.

It is assumed that the size of the third object file S3 does not exceed 50 MB. Consequently, the controlling unit 13 performs the step G2 after the step G3. In the step G2, the third object file S3 is copied from the high power consumption storage component 11 by the controlling unit 13, so that the copied third object file S3 is stored in the sub-storage space 1212 of the low power consumption storage component 12. After the third requesting step G is completed, the controlling unit 13 performs the transmitting step E. That is, the third object file S3 in the sub-storage space 1212 is transmitted to the active device 2. Consequently, the third object file S3 is executed by the active device 2. Moreover, at the time when the second request command R2 is received by the controlling unit 13 in the detecting step F1, the prediction module 14 starts performing the recording step D. The procedures of the recording step D are similar to those mentioned above, and are not redundantly described herein. After the recording step D is completed, a second file information about the third object file S3 is added to the operating practice information corresponding to the active device 2.

After the transmitting step E is completed, the controlling unit 13 performs the detecting step F2 of judging whether a new request command from the active device 2 is received. If the user does not operate the active device 2 to browse other object file of the hard disk device 1, the controlling unit 13 judges that no new request command from the active device 2 is received in the detecting step F2. Consequently, the controlling unit 13 performs the transmission judging step H. Since the third object file S3 corresponding to the second request command R2 has been transmitted to the active device 2, the controlling unit 13 judges that the third object file S3 is completely transmitted in the transmission judging step H. Meanwhile, the procedure of transmitting the third object file S3 is ended.

The following two aspects should be specially described. Firstly, the process of transmitting the third object file S3 has the following features. After the user operates the active device 2 to allow the active device 2 to be connected with the hard disk device 1 again and before the second request command R2 is outputted from the active device 2, the first file information corresponding to the active device 2 is firstly read from the operating practice information by the controlling unit 13 and then the second object file S2 corresponding to the first file information is copied from the high power consumption storage component 11 to the low power consumption storage component 12. The timing of copying the second object file S2 to the low power consumption storage component 12 is specially arranged by the controlling unit 13. In particular, the second object file S2 is copied to the low power consumption storage component 12 during the operation of the high power consumption storage component 11. Consequently, the total run time of the high power consumption storage component 11 is reduced. If the user wants to operate the active device 2 to open the second object file S2, the second object file S2 stored in the low power consumption storage component 12 is directly transmitted to the active device 2 by the controlling unit 13. Since it is not necessary to access the second object file S2 from the high power consumption storage component 11, the power consumption can be reduced.

Secondly, after the second requesting step C, if the user wants to operate the active device 2 to open the second object file S2, the first request command R1 corresponding to the second object file S2 is transmitted from the active device 2 to the hard disk device 1. Then, in the detecting step F1, the controlling unit 13 judges whether a new request command from the active device 2 is received. As mentioned above, the first request command R1 has been received by the controlling unit 13, and the second object file S2 corresponding to the first request command R1 has been stored in the low power consumption storage component 12. Under this circumstance, the controlling unit 13 judges that no new request command from the active device is received in the detecting step F1 because the first request command R1 is not considered as the new request command by the controlling unit 13. Since the judging condition of the detecting step F1 is not satisfied, the transmitting step E is performed.

The procedure of establishing the wireless connection between the active device 2 and the hard disk device 1 for the third time will be illustrated as follows. Please refer to FIGS. 1 and 2 again. After the power consumption reducing method of the present invention is started again, the partitioning step P is no longer performed by the controlling unit 13. Then, the connecting step A is performed. Since the device identification information corresponding to the active device 2 has existed in the hard disk device 1, the controlling unit 13 judges that the active device 2 is connected with the hard disk device 1 not for the first time. Then, the second requesting step C is performed. In the step C1, the associated information of the second object file S2 and the associated information of the third object file S3 are retrieved from the first file information and the second file information by the controlling unit 13. Then, in the step C2, the file attributes of the second object file S2 and the third object file S3 are judged by the controlling unit 13. On one hand, the controlling unit 13 performs the step C2 and the step C3. Consequently, the second object file S2 is copied from the high power consumption storage component 11, and the copied second object file S2 is stored in the sub-storage space 1211 of the low power consumption storage component 12 again. On the other hand, the controlling unit 13 performs the step C2, the step C4 and the step C3 sequentially. Consequently, the third object file S3 is copied from the high power consumption storage component 11, and the copied third object file S3 is stored in the sub-storage space 1212 of the low power consumption storage component 12 again. After the second requesting step C is completed, the controlling unit 13 performs the detecting step F1 of judging whether a new request command from the active device 2 is received.

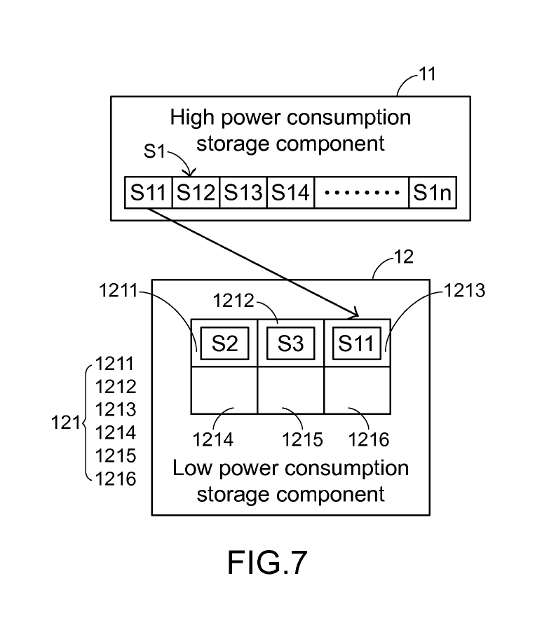

Please refer to FIGS. 1, 2 and 6. If the user wants to open the first object file S1, the user may operate the active device 2 to allow a third request command R3 corresponding to the first object file S1 to be transmitted to the hard disk device 1. Consequently, in the detecting step F1, the controlling unit 13 judges that the third request command R3 is received. Then, the controlling unit 13 performs the third requesting step G and the recording step D. In the step G1 of the third requesting step G, the file attribute of the first object file S1 corresponding to the third request command R3 is judged by the controlling unit 13. Since the first object file S1 is a video file, the controlling unit 13 judges that the file attribute of the first object file S1 is a video attribute. Then, the controlling unit 13 performs the step G3 of judging whether the size of the first object file S1 exceeds the threshold size value. For example, the threshold size value in the controlling unit 13 is 50 MB. It is assumed that the size of the first object file S1 exceeds 50 MB. Consequently, the controlling unit 13 performs the step G4. In the step G4, the first object file S1 is partitioned into plural file segments S11˜S1n and the file segment S11 is copied to the sub-storage space 1213 of the low power consumption storage component 12. The way of partitioning the first object file S1 into the plural file segments S11˜S1n is shown in FIG. 7.

After the third requesting step G is completed, the controlling unit 13 performs the transmitting step E. That is, the file segment S11 of the first object file S1 in the sub-storage space 1213 is transmitted to the active device 2. Consequently, the file segment S11 is executed by the active device 2. Moreover, at the time when the third request command R3 is received by the controlling unit 13 in the detecting step F1, the prediction module 14 starts performing the recording step D. The procedures of the recording step D are similar to those mentioned above, and are not redundantly described herein.

After the transmitting step E is completed, the controlling unit 13 performs the detecting step F2 of judging whether a new request command from the active device 2 is received. If the user does not operate the active device 2 to browse other object file of the hard disk device 1, the controlling unit 13 judges that no new request command from the active device 2 is received in the detecting step F2. Consequently, the controlling unit 13 performs the transmission judging step H. Since the controlling unit 13 judges that no new request command from the active device 2 is received in the detecting step F2, it means that no additional object file needs to be read and the first object file S1 needs to be continuously executed. That is, the video file is continuously played. In the transmission judging step H, the controlling unit 13 judges that only the file segment S11 of the first object file S1 is completely transmitted but the other file segments S12˜S1n of the first object file S1 are not transmitted. Consequently, the controlling unit 13 performs the subsequent transmitting step I. In the subsequent transmitting step I, the next file segment S12 is copied from the high power consumption storage component 11 to the low power consumption storage component 12, and the next file segment S12 is transmitted to the active device 2. The transmission judging step H and the subsequent transmitting step I are repeatedly done until all of the file segments of the first object file S1 are completely transmitted to the active device 2 or the play command corresponding to the first object file S1 is stopped. Meanwhile, the procedure of transmitting the first object file S1 is ended.

The following three aspects should be specially described. Firstly, if the wireless connection between the active device 2 and the hard disk device 1 is established for the fourth time after the procedure of transmitting the first object file S1 is ended, all of the file information corresponding to the active device 2 will be firstly read from the operating practice information by the controlling unit 13, and then the second object file S2, the third object file S3 and the file segment S11 of the first object file S1 are copied from the high power consumption storage component 11 to the low power consumption storage component 12. If the user wants to operate the active device 2 to open the previously-used third object file S3, the third object file S3 stored in the low power consumption storage component 12 is directly transmitted to the active device 2 by the controlling unit 13. Under this circumstance, it is not necessary to access the third object file S3 from the high power consumption storage component 11.

Secondly, in a preferred embodiment, when the user operates the active device 2 to request the first object file S1, the first object file S1 is partitioned into plural file segments S11˜S1n by the controlling unit 13, and the file segments S11 and S12 are respectively stored in two consecutive sub-storage spaces (e.g. the sub-storage spaces 1211 and 1212) of the low power consumption storage component 12. Consequently, the power consumption of the low power consumption storage component 12 during operation is reduced. In other words, the power-saving efficacy is further enhanced.

Thirdly, in this embodiment, the hard disk device is connected with a single active device. It is noted that numerous modifications and alterations may be made while retaining the teachings of the invention. In practice, the hard disk device of the present invention may be connected with plural active devices simultaneously according to the hardware performance. Consequently, the power consumption reducing method of the present invention can be simultaneously performed by the hard disk device and the plural active devices.

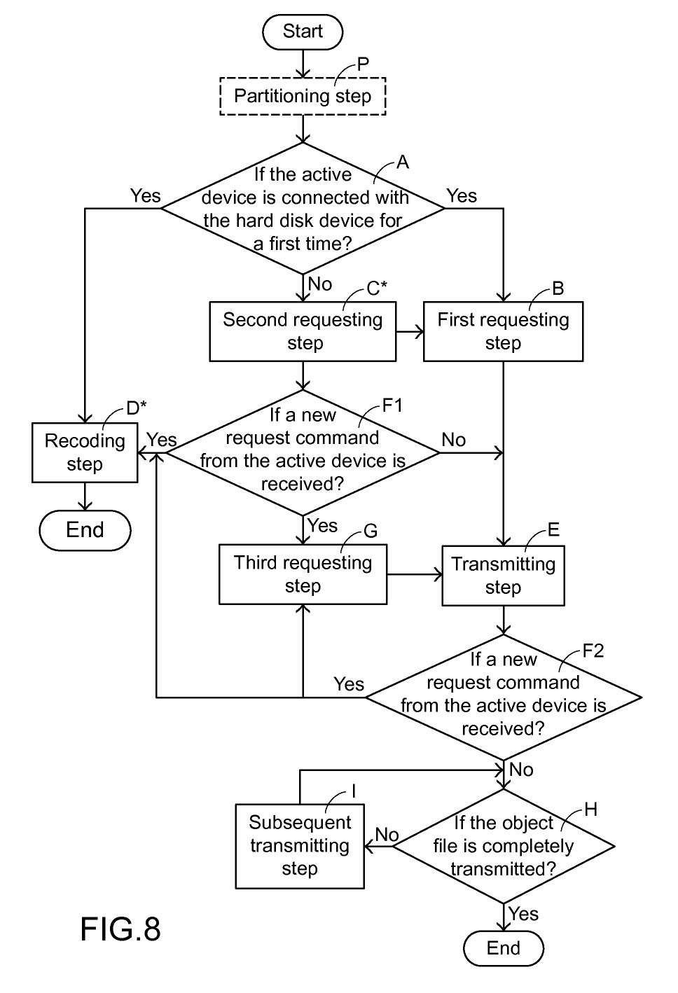

The present invention further provides a power consumption reducing method of a second embodiment, which is distinguished from the first embodiment. Please refer to FIGS. 1 and 8. FIG. 8 is a flowchart illustrating a power consumption reducing method for the hard disk device according to a second embodiment of the present invention. The power consumption reducing method of the second embodiment comprises the following steps. In a partitioning step P, the storage space of the low power consumption storage component is allocated into plural consecutive sub-storage spaces, and the plural consecutive sub-storage spaces are assigned to the active device. In a connecting step A, the hard disk device is connected with the active device and judges whether the active device is connected with the hard disk device for a first time. In a first requesting step B, a corresponding object file or at least one file segment of the corresponding object file is copied from the high power consumption storage component to the low power consumption storage component according to a first request command from the active device. In a second requesting step C*, a corresponding object file or at least one file segment of the corresponding object file is copied from the high power consumption storage component to the low power consumption storage component according to an operating practice information with the proviso that the power consumption rate of performing the second requesting step does not exceed a predetermined power consumption rate. In a recoding step D*, the operating behavior of the active device is recorded as an operating practice information, and a procedure of gathering statistics about the operating practice information is performed. In a transmitting step E, the corresponding object file or the at least one file segment is transmitted to the active device. The detecting steps F1 and F2 are performed to judge whether a new request command from the active device is received. In a third requesting step G a corresponding object file or at least one file segment of the corresponding object file is copied from the high power consumption storage component to the low power consumption storage component according to the new request command from the active device. The transmission judging step H is performed to judge whether the object file is completely transmitted. In a subsequent transmitting step I, a next file segment is copied from the high power consumption storage component to the low power consumption storage component, and the next file segment is transmitted to the active device.

In comparison with the power consumption reducing method of the first embodiment, the second requesting step C is replaced by the second requesting step C* of this embodiment, and the recording step D is replaced by the recording step D* of this embodiment. Whereas, if the power consumption rate of performing the second requesting step exceeds the predetermined power consumption rate, the first requesting step B is continuously performed. If the power consumption rate of performing the second requesting step does not exceed the predetermined power consumption rate, the second requesting step C* is continuously performed.

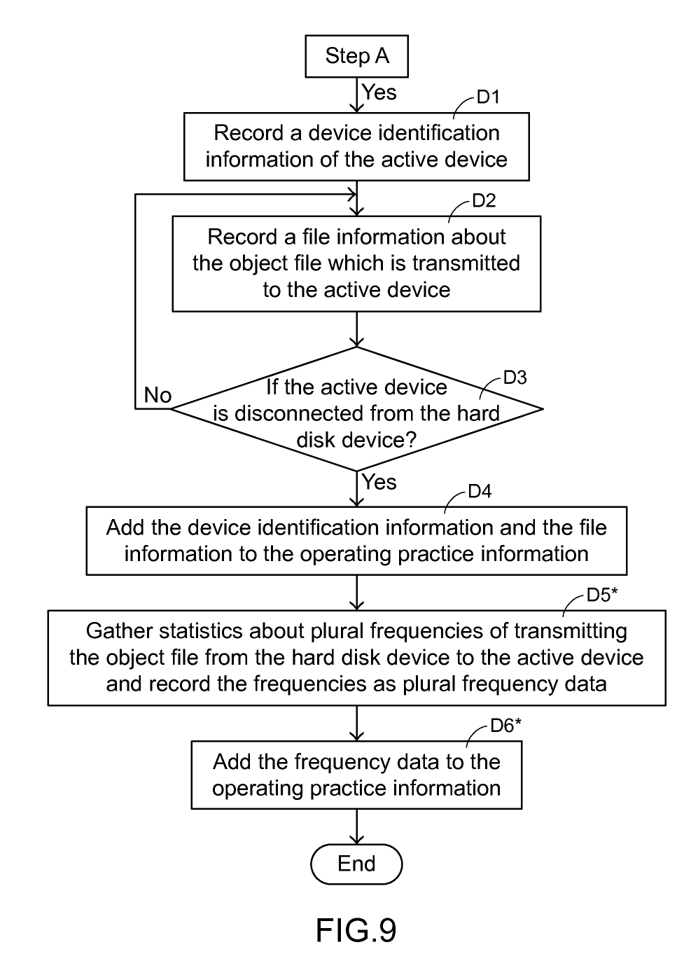

The detailed procedures of the recoding step D* of the power consumption reducing method of the present invention will be illustrated as follows. FIG. 9 is a flowchart illustrating the recoding step D* of the power consumption reducing method according to the second embodiment of the present invention. The recoding step D* comprises the following steps D1˜D4 and D5*˜D6*. In the step D1, a device identification information of the active device is recorded. In the step D2, a file information about the object file which is transmitted to the active device is recorded. The step D3 is performed to judge whether the active device is disconnected from the hard disk device. In the step D4, the device identification information and the file information are added to the operating practice information. The step D5* is performed for gathering statistics about plural frequencies of transmitting plural object files from the hard disk device to the active device, and recording the plural frequencies as plural frequency data. In the step D6*, the plural frequency data are added to the operating practice information.

That is, after the step D4 of the first embodiment, the recoding step D* of the second embodiment further comprises the steps D5* and D6*. In the step D5*, the frequencies of transmitting the plural object files from the hard disk device 1 to the active device 2 are gathered by a statistics method, and these frequencies are recorded as plural frequency data. In the step D6*, the plural frequency data are added to the operating practice information.

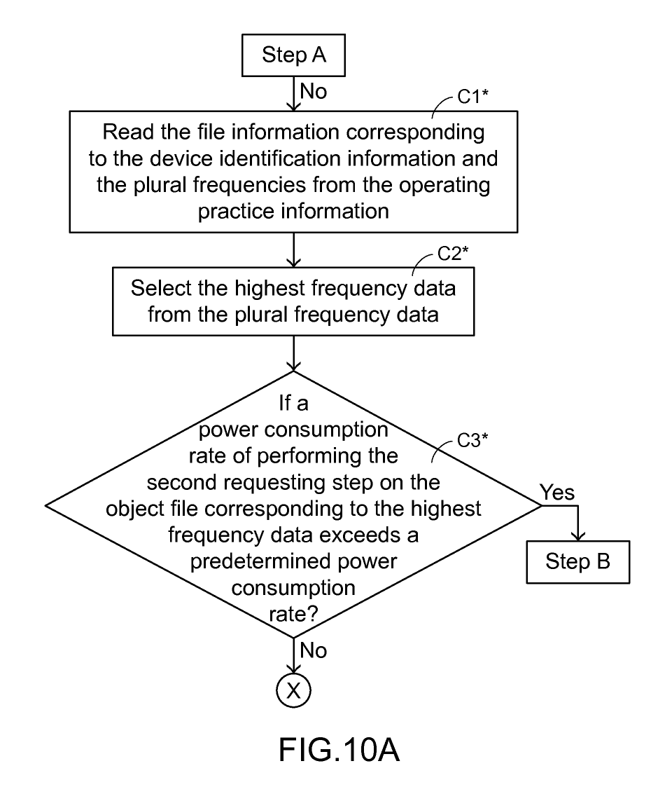

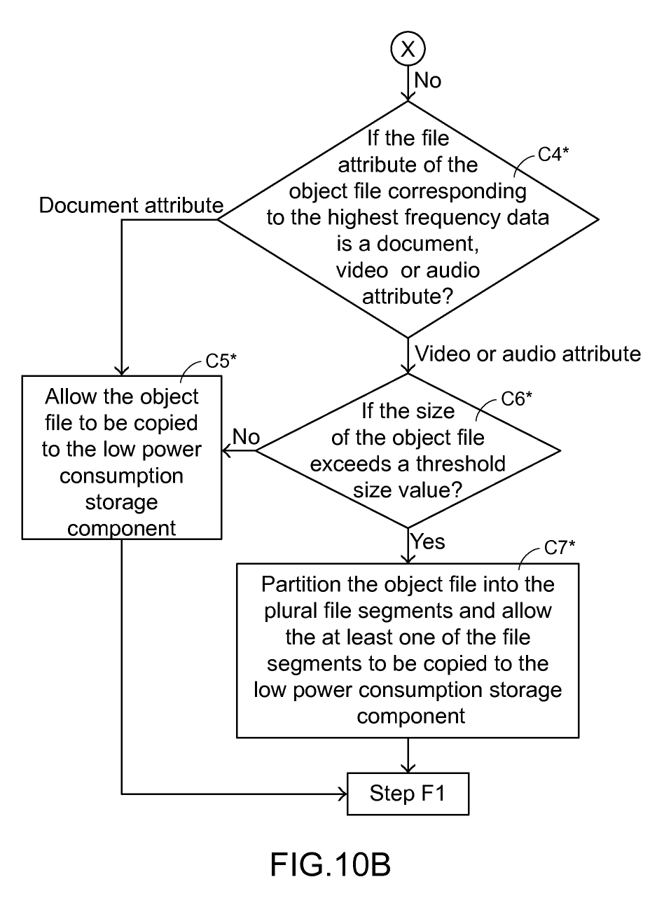

The detailed procedures of the second requesting step C* of the power consumption reducing method of the present invention will be illustrated as follows. FIG. 10A and FIG. 10B are flowcharts illustrating the second requesting step C* of the power consumption reducing method according to the second embodiment of the present invention. The second requesting step C* comprises the following steps C1*˜C7*. In the step C1*, the file information corresponding to the device identification information and the plural frequency data are read from the operating practice information. In the step C2*, the highest frequency data is selected from the plural frequency data. The step C3* is performed to judge whether a power consumption rate of performing the second requesting step on the object file corresponding to the highest frequency data exceeds a predetermined power consumption rate. In the step C4*, the file attribute of the object file corresponding to the highest frequency data is judged. In the step C5*, the object file is copied to the low power consumption storage component. The step C6* is performed to judge whether the size of the object file exceeds a threshold size value. In the step C7*, the object file is partitioned into plural file segments and at least one of the file segments is copied to the low power consumption storage component.

In comparison with the power consumption reducing method of the first embodiment, the second requesting step C* further comprises the steps C1*˜C3*. Moreover, the steps C4*˜C7* of the second requesting step C* of this embodiment are similar to the steps C2˜C5 of the second requesting step C of the first embodiment.

When the user operates the active device 2 to allow the active device 2 to be in wireless communication with the hard disk device 1 again, the controlling unit 13 sequentially performs the partitioning step P and the connecting step A. Since the device identification information corresponding to the active device 2 has existed in the hard disk device 1, in the connecting step A, the controlling unit 13 judges that the active device 2 is connected with the hard disk device 1 not for the first time. Then, the second requesting step C* is performed. In the step C1*, the associated information of the object files corresponding to the active device 2 and the plural frequency data are retrieved from the first file information and the second file information by the controlling unit 13. For example, in the recording step D*, the frequency data corresponding to the first object file S1 is recorded as 5, the frequency data corresponding to the second object file S2 is recorded as 20, and the frequency data corresponding to the third object file S3 is recorded as 17.

Then, in the step C2*, the controlling unit 13 selects the second object file S2 with the highest frequency data. In the step C3*, the controlling unit 13 judges whether the power consumption rate of performing the second requesting step on the second object file S2 exceeds the predetermined power consumption rate. The predetermined power consumption rate is the power consumption rate of directly transmitting the second object file S2 from the high power consumption storage component 11 to the active device 2. The power consumption rate of performing the second requesting step on the second object file S2 is the power consumption rate of copying the second object file S2 to the low power consumption storage component 12 and then transmitting the second object file S2 from the low power consumption storage component 12 to the active device 2. Then, the power consumption rate of performing the second requesting step on the second object file S2 and the predetermined power consumption rate are calculated by the controlling unit 13. If the controlling unit 13 judges that the power consumption rate of performing the second requesting step on the second object file S2 exceeds the predetermined power consumption rate, it means that the second requesting step C* is not power-saving. Under this circumstance, the controlling unit 13 stops the second requesting step C* but performs the first requesting step B. On the other hand, if the second requesting step C* is more power-saving, the controlling unit 13 will continuously perform the steps C4*˜C7* of the second requesting step C*. The operations of the steps C4*˜C7* of the second requesting step C* are similar to the steps C2˜C5 of the second requesting step C of the first embodiment, and are not redundantly described herein.

The following three aspects should be specially described. Firstly, the prediction module 14 may gather statistics to obtain plural most frequently used object files in the recording step D*, and the controlling unit 13 may copy plural frequently used object files to the low power consumption storage component 12 in the second requesting step C*. Consequently, the object files that are possibly used by the user according to the operating practice of the user can be predicted. Secondly, the controlling unit 13 may operate the second requesting step C* and the recording step D* in coordination, thereby acquiring the most frequently used object files. Moreover, the controlling unit 13 may judge whether the power consumption rate of performing the second requesting step on the second object file S2 exceeds the power consumption rate of directly transmitting the second object file S2 from the high power consumption storage component 11 to the active device 2. Consequently, the more power-saving procedure is adopted to increase the power-saving efficacy. Thirdly, in a preferred embodiment, plural object files with the highest frequency data are selected in the step C2*. That is, plural object files are copied from the low power consumption storage component 12 to the high power consumption storage component 11, so that the second requesting step C* is performed on the plural object files.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A power consumption reducing method for a hard disk device, the power consumption reducing method comprising steps of:
allowing the hard disk device to be connected with an active device;
judging whether the hard disk device is connected with the active device for a first time;
selectively performing a first requesting step of allowing an object file or at least one file segment of the object file to be copied from a high power consumption storage component of the hard disk device to a low power consumption storage component of the hard disk device according to a request command from the active device, and recording an operating behavior of the active device as an operating practice information;
selectively performing a second requesting step of allowing the object file or the at least one file segment of the object file to be copied from the high power consumption storage component to the low power consumption storage component according to the operating practice information;
transmitting the object file or the at least one file segment of the object file to the active device; and
judging whether all file segments of the object file are completely transmitted to the active device.

2. The power consumption reducing method according to claim 1, wherein if the hard disk device judges that the hard disk device is connected with the active device for the first time, the object file or the at least one file segment of the object file is copied from the high power consumption storage component to the low power consumption storage component according to the request command from the active device, and the operating behavior of the active device is recorded as the operating practice information, wherein if the hard disk device judges that the hard disk device is connected with the active device not for the first time, the object file or the at least one file segment of the object file is copied from the high power consumption storage component to the low power consumption storage component according to the operating practice information.

3. The power consumption reducing method according to claim 1, wherein the step of recording the operating behavior of the active device as the operating practice information comprising steps of:
recording a device identification information of the active device;
recording a file information about the object file which is transmitted to the active device; and
adding the device identification information and the file information to the operating practice information.

4. The power consumption reducing method according to claim 3, wherein the second requesting step comprises steps of:
reading the file information corresponding to the device identification information from the operating practice information; and
recognizing a file attribute of the object file corresponding to the file information, wherein according to the file attribute of the object file, the object file is partitioned into the plural file segments and the at least one of the file segments is copied to the low power consumption storage component, or the object file is copied to the low power consumption storage component.

5. The power consumption reducing method according to claim 3, wherein after the step of adding the device identification information and the file information to the operating practice information, the power consumption reducing method further comprises steps of:
gathering statistics about plural frequencies of transmitting plural object files from the hard disk device to the active device, and recording the plural frequencies as plural frequency data; and
adding the plural frequency data to the operating practice information.

6. The power consumption reducing method according to claim 5, wherein the second requesting step comprises steps of:
reading the file information corresponding to the device identification information and the plural frequency data from the operating practice information;
selecting the highest frequency data from the plural frequency data;
judging whether a power consumption rate of performing the second requesting step on the object file corresponding to the highest frequency data exceeds a predetermined power consumption rate; and
if the power consumption rate of performing the second requesting step on the object file corresponding to the highest frequency data does not exceed the predetermined power consumption rate, recognizing a file attribute of the object file corresponding to the highest frequency data, wherein according to the file attribute of the object file, the object file is partitioned into the plural file segments and the at least one of the file segments is copied to the low power consumption storage component, or the object file is copied to the low power consumption storage component

7. The power consumption reducing method according to claim 3, wherein the first requesting step comprises steps of:
receiving the request command; and
recognizing a file attribute of the object file corresponding to the request command, wherein according to the file attribute of the object file, the object file is partitioned into the plural file segments and the at least one of the file segments is copied to the low power consumption storage component, or the object file is copied to the low power consumption storage component.

8. The power consumption reducing method according to claim 1, wherein if the hard disk device judge that all file segments of the object file are not completely transmitted to the active device, a next file segment of the object file is copied from the high power consumption storage component to the low power consumption storage component, and the next file segment is transmitted to the active device.

9. The power consumption reducing method according to claim 1, wherein after the second requesting step, the power consumption reducing method further comprises a first detecting step of judging whether a new request command from the active device is received, wherein if the new request command from the active device is received, an additional object file or at least one file segment of the additional object file is copied from the high power consumption storage component to the low power consumption storage component according to the new request command, and the operating behavior of the active device is recorded as the operating practice information, wherein if no new request command from the active device is received, the object file or the at least one file segment of the object file is transmitted to the active device.

10. The power consumption reducing method according to claim 1, wherein after the step of transmitting the object file or the at least one file segment of the object file to the active device, the power consumption reducing method further comprises a second detecting step of judging whether a new request command from the active device is received, wherein if no new request command from the active device is received, the hard disk device further judges whether all file segments of the object file are completely transmitted to the active device, wherein if the new request command from the active device is received, an additional object file or at least one file segment of the additional object file is copied from the high power consumption storage component to the low power consumption storage component according to the new request command, and the operating behavior of the active device is recorded as the operating practice information.

11. A hard disk device with reduced power consumption, the hard disk device being connected with an active device, the hard disk device comprising:
a high power consumption storage component disposed within the hard disk device, and storing an object file;
a low power consumption storage component disposed within the hard disk device and connected with the high power consumption storage component;
a controlling unit connected with the high power consumption storage component and the low power consumption storage component, wherein according to a request command from the active device, the object file or at least one file segment of the object file is copied from the high power consumption storage component to the low power consumption storage component by the controlling unit, and the object file or the at least one file segment is transmitted from the low power consumption storage component to the active device by the controlling unit; and
a prediction module connected with the controlling unit, wherein according to the request command, an operating behavior of the active device is recorded as an operating practice information by the prediction module, wherein when the active device is connected with the hard disk device not for a first time, the object file or the at least one file segment corresponding to the operating practice information is copied from the high power consumption storage component to the low power consumption storage component by the controlling unit according to the operating practice information of the prediction module.

12. The hard disk device according to claim 11, wherein the active device is recognized by the controlling unit, the controlling unit judges whether the active device is connected with the hard disk device for the first time, wherein if the controlling unit judges that the active device is connected with the hard disk device for the first time, the controlling unit allows the prediction module to record the operating behavior of the active device as the operating practice information, wherein if the controlling unit judges that the active device is connected with the hard disk device not for the first time, a file information is retrieved from the operating practice information of the prediction module by the controlling unit, and the object file or at least one file segment of the object file corresponding to the file information is copied from the high power consumption storage component to the low power consumption storage component by the controlling unit according to the file information.

13. The hard disk device according to claim 11, wherein a file attribute of the object file is recognized by the controlling unit, wherein according to the file attribute of the object file, the object file is partitioned into the plural file segments and the at least one of the file segments is copied to the low power consumption storage component by the controlling unit, or the object file is copied to the low power consumption storage component by the controlling unit.

14. The hard disk device according to claim 13, wherein if the controlling unit judges that the file attribute of the object file is a video attribute or an audio attribute, the object file is partitioned into the plural file segments and the at least one of the file segments is copied to the low power consumption storage component by the controlling unit, wherein if the controlling unit judges that the file attribute of the object file is a document attribute, the object file is copied to the low power consumption storage component by the controlling unit.

15. The hard disk device according to claim 11, wherein a storage space of the low power consumption storage component is previously allocated into plural consecutive sub-storage spaces by the controlling unit, wherein the plural consecutive sub-storage spaces are assigned to the active device by the controlling unit, so that the copied at least one segment is stored in the plural consecutive sub-storage spaces.
